(19) United States
(12) Patent Application Publication
(10) Pub. No.: US 2016/0234590 A1
(43) Pub. Date: Aug. 11, 2016

(54) SPEAKER SYSTEM

(71) Applicant: JVC KENWOOD Corporation, Yokohama-shi (JP)

(72) Inventors: Satoshi TOMIZAWA, Yokohama-shi (JP); Akira SHIGETA, Yokohama-shi (JP); Yusaku KATO, Yokohama-shi (JP)

(21) Appl. No.: 15/130,210

(22) Filed: Apr. 15, 2016

Related U.S. Application Data
(63) Continuation-in-part of application No. PCT/JP2014/003175, filed on Jun. 13, 2014.

(30) Foreign Application Priority Data
Oct. 18, 2013 (JP) 2013-217231

(51) Int. Cl. H04R 1/28; H04R 1/26; H04R 1/24

(52) U.S. Cl. CPC H04R 1/2826; H04R 1/24; H04R 1/26

(57) ABSTRACT

A speaker system includes a first loudspeaker, a second loudspeaker, and a panel. The second loudspeaker is provided in front of the first loudspeaker and outputs a sound in a frequency range different from that of the first loudspeaker. The panel is provided on a front surface of the second loudspeaker. The panel includes a peripheral portion provided along an outer periphery of a diaphragm of the second loudspeaker. In the peripheral portion, at least one through-hole penetrating the panel in a sound output direction of the first and second loudspeakers is formed along an outer peripheral direction.

This application is a Continuation-In-Part of PCT Application No. PCT/JP2014/003175, filed Jun. 13, 2014, and claims the benefit of JP Application No. 2013-217231, filed Oct. 18, 2013, the contents of which are incorporated by reference.

### TECHNICAL FIELD

The present invention relates to a speaker system that outputs a sound.

### BACKGROUND ART

In recent years, a speaker system has been developed in which a plurality of loudspeakers are coaxially provided so as to precisely reproduce a sound from a low-frequency range to a high-frequency range. For example, a speaker system including a first loudspeaker; a second loudspeaker that is provided in front of the first loudspeaker and outputs a sound in a frequency range higher than that of the first loudspeaker; and a panel provided on a front surface of the second loudspeaker is known (see Patent Literature 1).

### CITATION LIST

### Patent Literature [Patent Literature 1] Japanese Unexamined Patent Application Publication No. 2008-136165

### SUMMARY OF INVENTION

### Technical Problem

However, in the speaker system disclosed in the above-mentioned Patent Literature 1, the panel is provided along the outer periphery of a diaphragm of the second loudspeaker and is located on the front side of the first loudspeaker. This causes a problem that the sound output from the first loudspeaker is blocked by the panel, which results in degrading the sound quality. The size of the panel can be reduced so as not to block the sound. However, this may result in the degradation of the design due to the panel.

The present invention has been made to solve the above-mentioned problem, and a principal object of the present invention is to provide a speaker system that achieves a high quality design while maintaining a high quality sound.

### Solution to Problem

The present invention includes a first loudspeaker; a second loudspeaker that is provided in front of the first loudspeaker and outputs a sound in a frequency range different from that of the first loudspeaker; and a panel provided on a front surface of the second loudspeaker. The panel includes a peripheral portion provided along an outer periphery of a diaphragm of the second loudspeaker. The panel has a diameter that is 2.5 times or less the diameter of a voice coil included in the first speaker. A distance from a neck portion included in the first speaker to the panel is equal to an integral multiple of a wavelength or a half-wave length of a frequency band of sound output from the vicinity of the neck portion. In the peripheral portion, at least one through-hole penetrating the panel in a sound output direction of the first and second loudspeakers is formed at a position opposed to the neck portion along an outer peripheral direction.

### Advantageous Effects of Invention

According to the present invention, it is possible to provide a speaker system that achieves a high quality design while maintaining a high quality sound.

### BRIEF DESCRIPTION OF DRAWINGS

FIG. 1 is a perspective view showing a schematic configuration of a speaker system according to an embodiment of the present invention;

FIG. 2 is a perspective view showing a schematic configuration of a panel according to an embodiment of the present invention;

FIG. 3 is a top view of the panel shown in FIG. 2;

FIG. 4 is a view showing a neck portion where a diaphragm and a voice coil of a first loudspeaker are connected to each other;

FIG. 5 is a top view of a panel in which nine through-holes are provided at regular intervals in a peripheral portion;

FIG. 6 is a sectional view of the panel taken along a line A-A shown in FIG. 5;

FIG. 7 is a partially enlarged sectional view of a portion “B” shown in FIG. 6;

FIG. 8 is a graph showing frequency characteristics when each through-hole according to an embodiment of the present invention is formed in the panel;

FIG. 9 is a view showing a through-hole formed so as to flare outward in a sound output direction of the first and second loudspeakers; and

FIG. 10 is a diagram showing the height of the panel.

### DESCRIPTION OF EMBODIMENTS

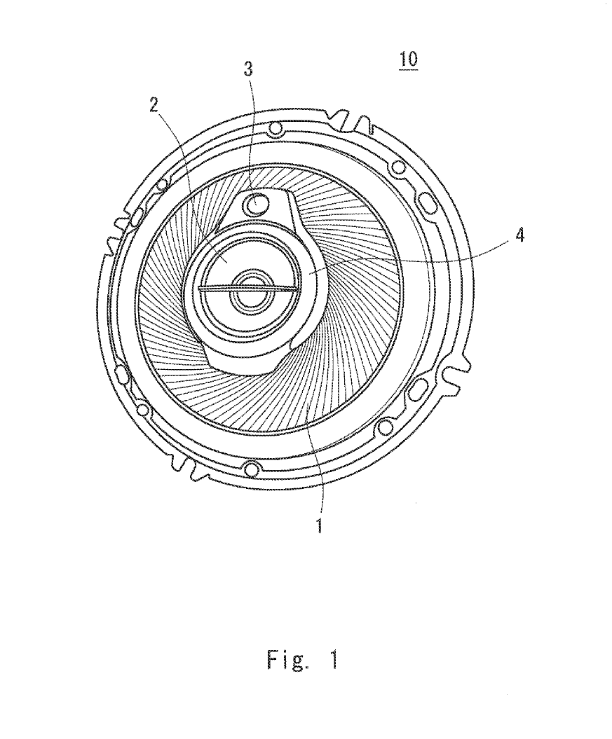

An embodiment of the present invention will be described below with reference to the drawings. FIG. 1 is a perspective view showing a schematic configuration of a speaker system according to an embodiment of the present invention. A speaker system 10 according to this embodiment includes: a first loudspeaker 1 that mainly outputs a sound in a low-frequency range; a second loudspeaker 2 that mainly outputs a sound from a mid-frequency range to a high-frequency range; a third loudspeaker 3 that mainly outputs a sound in an ultra-high-frequency range (for example, about 10 to 200 kHz) which is higher than the high-frequency range of the second loudspeaker 2; and a panel 4 that is provided on a front surface of the second loudspeaker 2.

The first loudspeaker 1 is a so-called woofer (WF) which is a speaker unit composed of a diaphragm, a voice coil, and the like. The second loudspeaker 2 is a so-called tweeter (TW). Similarly to the first loudspeaker 1, the second loudspeaker 2 is a speaker unit composed of a diaphragm, a voice coil, and the like. The second loudspeaker 2 is provided in front of the first loudspeaker 1 and at a position overlapping the projection plane of the diaphragm of the first loudspeaker 1. The third loudspeaker 3 is a so-called supertweeter (S-TW). Similarly to the second loudspeaker 2, the third loudspeaker 3 is a speaker unit composed of a diaphragm, a voice coil, and the like. The third loudspeaker 3 is provided in front of the first loudspeaker 1 and beside the second loudspeaker 2. The speaker system 10 according to this embodiment includes the third loudspeaker 3. However, the configuration of the speaker system 10 is not limited to this. For example, the speaker system 10 may not include the third loudspeaker 3. The second loudspeaker 2 and the third loudspeaker 3 may be coaxially provided in front of the first loudspeaker. Further, the first to third loudspeakers 1, 2, and 3 may be configured as another drive system, such as a piezo-electric element, instead of using the above-mentioned voice coil.

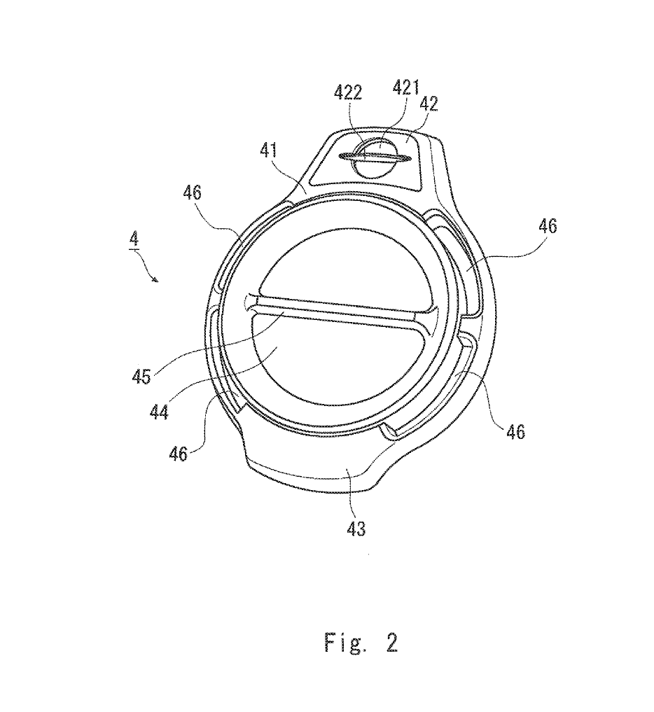

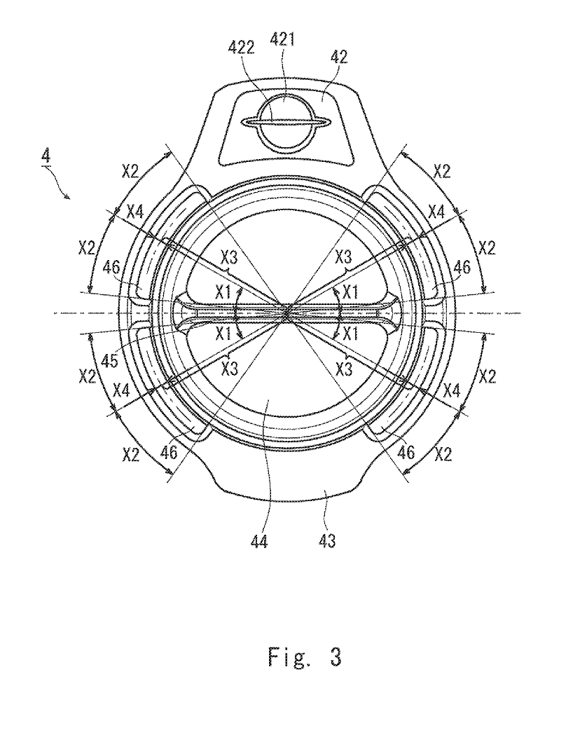

FIG. 2 is a perspective view showing a schematic configuration of the panel according to this embodiment. FIG. 3 is a top view of the panel shown in FIG. 2. The panel 4 is a member that has, for example, a substantially annular shape, and is formed of a synthetic resin such as plastic. The panel 4 is provided along the outer periphery of the diaphragm of the second loudspeaker 2. The panel 4 covers the outer periphery of the second loudspeaker 2 which is provided in the vicinity of the center of the first loudspeaker 1. The beauty of the shape of the panel contributes to achieving a high quality design for the speaker system 10. Specifically, the configuration in which the panel 4 covers the outer periphery of the second loudspeaker 2 has such an effect that the entire system including the first loudspeaker looks well-organized and the aperture of the second loudspeaker 2 looks larger than its actual size.

The panel 4 includes a peripheral portion 41 that is provided along the outer periphery of the diaphragm of the second loudspeaker 2; a first projecting portion 42 that projects outward from the peripheral portion 41 and is provided with the third loudspeaker 3; a second projecting portion 43 that projects outward from the peripheral portion 41 at a position opposed to the first projecting portion 42; and a transition portion 45 that extends across an annular opening 44.

The panel 4 is provided with the transition portion 45 for the purpose of protecting the second loudspeaker 2. However, for the purpose of improving the sound quality of the second loudspeaker 2, the panel 4 may not be provided with the transition portion 45. The first projecting portion 42 has an opening 421 with a substantially circular shape. The diaphragm of the third loudspeaker 3 is exposed from the opening 421, which allows the third loudspeaker 3 to output a sound through the opening 421. The opening 421 may be provided with a transition portion 422 extending across the opening, for the purpose of protecting the third loudspeaker 3.

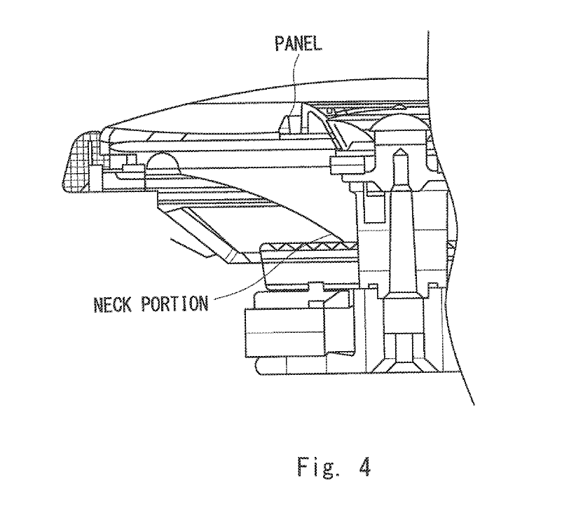

Heretofore, there has been a problem that when the panel is provided along the outer periphery of the diaphragm of the second loudspeaker, the sound output from the first loudspeaker is blocked by the panel, which results in the degradation of the sound quality. A portion (neck portion) where the diaphragm and the voice coil of the first loudspeaker are connected to each other serves as an innermost-peripheral-side sound output region of the first loudspeaker (FIG. 4). Accordingly, the sound in the high-frequency range (high frequency) is output from the diaphragm in the vicinity of the neck portion, which has a significant effect especially on the sound quality of the first loudspeaker. In other words, it is important to radiate the sound, which is output from the vicinity of the neck portion, to a user, without blocking the sound.

However, when the panel is provided along the outer periphery of the diaphragm of the second loudspeaker, the panel is located in the vicinity of the front side of the neck portion of the first loudspeaker and is opposed to a portion in the vicinity of the neck portion of the first loudspeaker. Accordingly, there is a possibility that the panel may block the sound output from the vicinity of the neck portion. Meanwhile, the size of the panel can be reduced so as not to block the sound. However, this may result in the degradation of the design due to the panel.

On the other hand, in the speaker system 10 according to this embodiment, at least one through-hole 46, which penetrates the panel in a sound output direction of the first and second loudspeakers 1 and 2, is formed along the outer peripheral direction in the peripheral portion 41 of the panel 4. Accordingly, the sound output from the vicinity of the neck portion of the first loudspeaker 1 passes through each through-hole 46, without being blocked by the panel 4, and is directly transmitted to the user. For this reason, the degradation of the sound quality can be effectively suppressed. Meanwhile, the degradation of the sound quality can be suppressed while maintaining the size of the panel 4. Thus, the beauty of the shape of the panel 4 contributes to achieving a high quality design for the speaker system. That is, a high quality design can be achieved while maintaining a high quality sound.

Note that since the large size of the panel 4 can be maintained, a secondary effect that the speaker system 10 has a highly merchantable quality can be expected. Specifically, maintaining the large size of the panel 4 allows the user to believe that the second loudspeaker 2 is larger than its actual size. Thus, it is believed that a larger sound (high output) is output from the second loudspeaker 2, which leads to an increase in the merchantable quality of the loudspeaker.

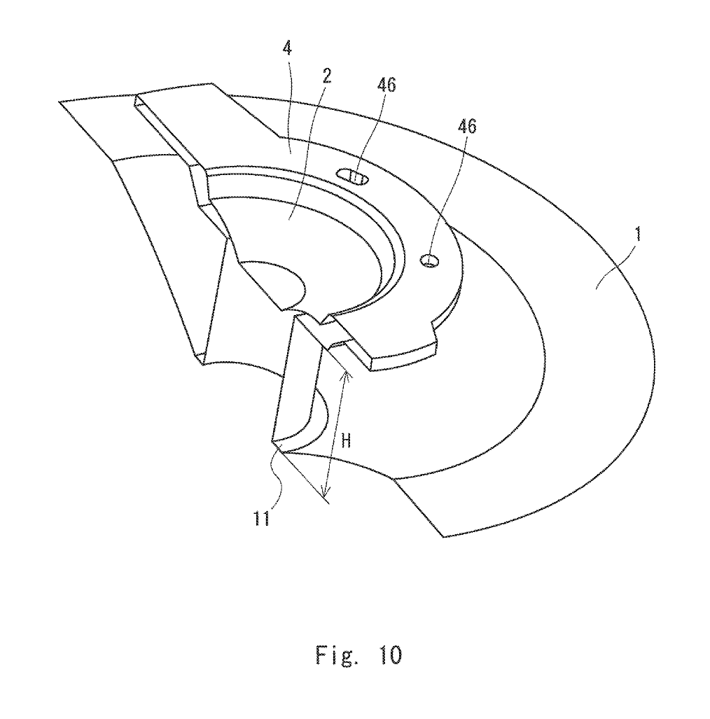

Further, in this embodiment, the panel 4 has a diameter that is 2.5 times or less the diameter of the voice coil included in the first speaker 1. The distance (the height H of the panel 4) from a neck portion 11 included in the first speaker 1 to the panel 4 is equal to an integral multiple of a wavelength or a half-wave length of a frequency band of sound output from the vicinity of the neck portion 11 (see FIG. 10).

The sound (high-frequency component) output from the vicinity of the neck portion 11 of the first speaker 1 is blocked by the panel 4. Due to the resonance in the characteristic frequency obtained when the height of the panel 4 is equal to the distance, DIP is generated in the characteristic frequency. However, the above-described configuration and the formation of the through-hole 46 in the panel 4 make it possible to further improve clear sound characteristics in the characteristic frequency.

For example, in the case of a wavelength in a frequency band of 4000 to 8000 Hz of sound output from the vicinity of the neck portion 11 of the first speaker 1, the height of the panel 4 is preferably 20 to 40 mm. Further, the height of the panel 4 is not limited to the integral multiple of the half-wave length of the frequency of sound output from the vicinity of the neck portion 11 of the first speaker 1. Also when the height of the panel 4 is equal to an integral multiple of the wavelength of the frequency of the sound, the same advantages effects can be obtained.

The through-holes 46 are formed, for example, at four positions, respectively, which are symmetrical to each other, along the peripheral direction of the peripheral portion 41. In the state where the panel 4 is provided along the outer periphery of the diaphragm of the second loudspeaker 2, each through-hole 46 of the panel 4 is opposed to a portion in the vicinity of the neck portion of the second loudspeaker 2. Accordingly, the sound in the high-frequency range output from the vicinity of the neck portion of the first loudspeaker 1 passes through each through hole 46, without being blocked by the panel 4, and is transmitted to the user. Note that the through-holes 46 shown in FIGS. 2 and 3 are examples only and are not particularly limited. The number, position, and size of the through-holes 46, which are formed in the peripheral portion 41, can be arbitrarily set.

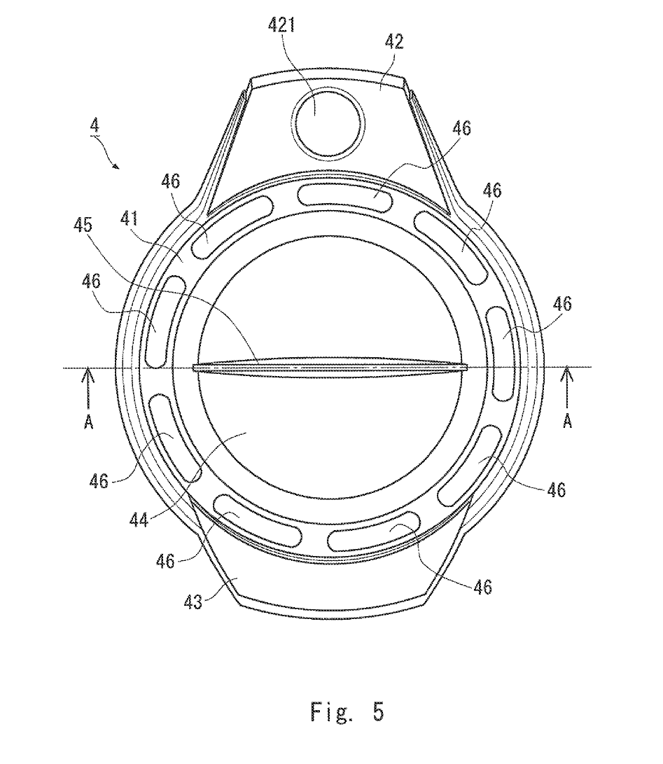

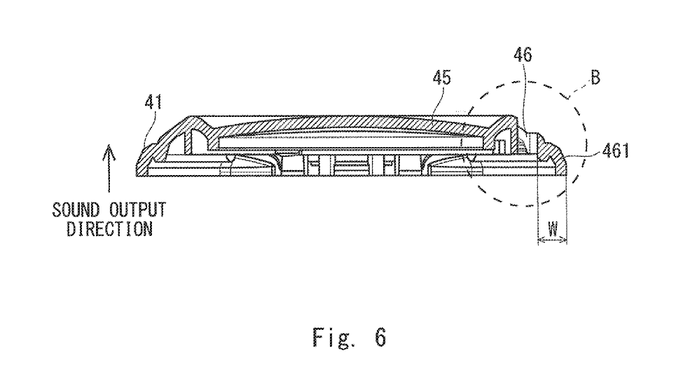

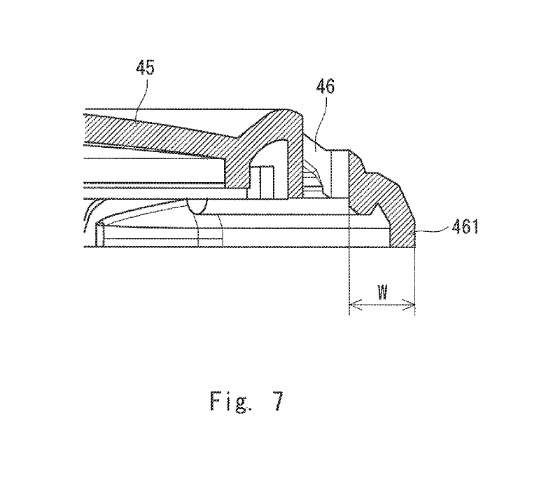

FIG. 5 is a top view of the panel in which nine through-holes are provided at regular intervals in the peripheral portion. FIG. 6 is a sectional view of the panel taken along a line A-A shown in FIG. 5. FIG. 7 is a partially enlarged sectional view of a portion “B” shown in FIG. 6.

As shown in FIG. 7, an isolation wall 461 extending in the sound output direction of the first and second loudspeakers 1 and 2 is formed outside the through-hole 46. This isolation wall 461 isolates the sound output from the first and second loudspeakers 1 and 2, thereby preventing the sound output from the first loudspeaker 1 from traveling to the second loudspeaker 2. For example, when the sound output from the first loudspeaker 1 travels to the second loudspeaker 2 and the sounds output from the first and second loudspeakers 1 and 2, respectively, have opposite phases, the sound output from the second loudspeaker 2 is reduced by the sound output from the first loudspeaker 1, which may result in the degradation of the sound quality. In this embodiment, the provision of the isolation wall 461 can suppress the degradation of the sound quality.

A thickness W of the isolation wall 461 is set to, for example, about 2.0 to 2.5 mm. However, the thickness W is not limited to this. For example, the thickness W may be set to about 3.0 mm. The thickness W can be arbitrarily set as long as the sound output from the first speaker can be prevented from traveling to the second speaker as described above.

For example, as shown in FIG. 3, an angle X1(°) of each through-hole 46 is an angle formed between a center line passing through the transition portion 45 and a radial center line passing through each through-hole 46. A lateral width X2 (°) of each through-hole 46 is an angle formed between a radial center line passing through each through-hole 46 and a radial center line passing through an end of each through-hole 46. A radial center X3 (mm) of each through-hole 46 is a distance from the center of the annular panel to the radial center position of each through-hole 46. A radial width X4 (mm) of each through-hole 46 is the width of each through-hole in the radial direction. Note that in this embodiment, the through-holes 46 have the same shape, but the shape of each through-hole 46 is not particularly limited. The through-holes 46 may have different shapes.

In this embodiment, the lateral width X2, the radial center X3, and the radial width X4 of each through-hole 46 of the panel 4 are appropriately set, thereby making it possible to control the frequency of the sound passing through each through-hole 46.

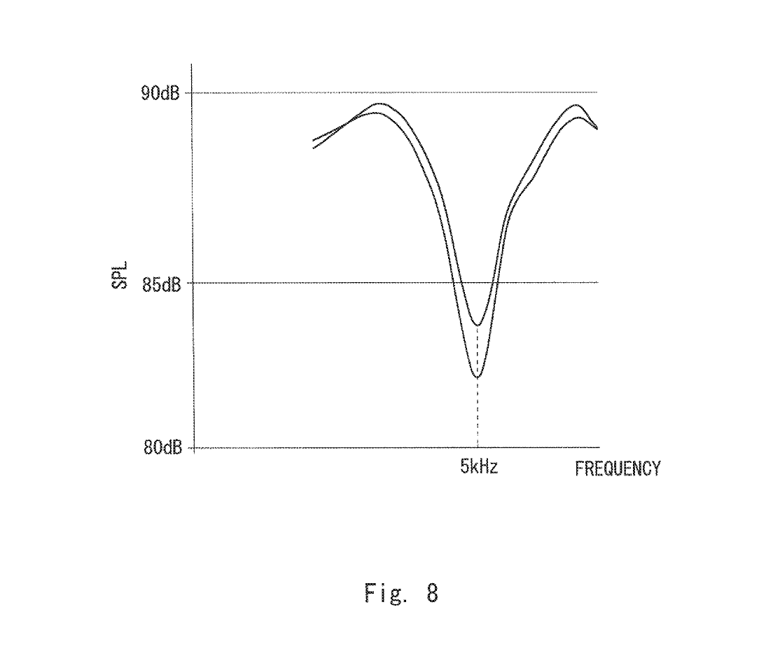

FIG. 8 is a graph showing frequency characteristics when each through-hole according to this embodiment is formed in the panel. In FIG. 8, the longitudinal axis represents a sound pressure level. As shown in FIG. 8, the DIP value is minimized in the vicinity of 5 kHz and resonance is generated. Thus, it can be found that the effect of a high quality sound due to each through-hole 46 of the panel 4 is maximized in the vicinity of 5 kHz.

In the embodiment described above, the plurality of through-holes 46 penetrating the panel in the sound output direction of the first and second loudspeakers 1 and 2 are formed along the outer peripheral direction in the peripheral portion 41 of the panel 4. With this configuration, a high quality design can be achieved while maintaining the high quality sound of the speaker system 10.

The isolation wall 461 that extends in the sound output direction of the first and second loudspeakers 1 and 2 and isolates the sound output from the first loudspeaker 1 from the sound output from the second loudspeaker 2 is provided outside the through-holes 46. With this configuration, the degradation of the sound quality caused when the sound output from the first loudspeaker 1 travels to the second loudspeaker 2 can be suppressed.

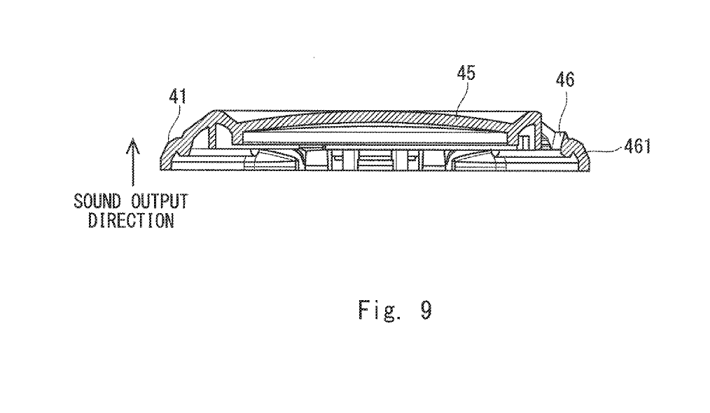

Note that the present invention is not limited to the above embodiment, and can be modified as appropriate without departing from the scope of the invention. For example, in the above embodiment, the shape of the upper end of each through-hole 46 is the same as that of the lower end of each through-hole 46, but the shapes of the upper and lower ends of each through-hole are not particularly limited. The upper end of each through-hole 46 may be formed with a radius greater than the radius of the lower end thereof. For example, as shown in FIG. 9, each through-hole 46 may be formed so as to flare outward in the sound output direction of the first and second loudspeakers 1 and 2. With this configuration, the effect of high quality sound due to the through-holes 46 becomes more satisfactory.

This application is based upon and claims the benefit of priority from Japanese patent application No. 2013-217231, filed on Oct. 18, 2013, the disclosure of which is incorporated herein in its entirety by reference.

### REFERENCE SIGNS LIST

1 FIRST LOUDSPEAKER
2 SECOND LOUDSPEAKER
3 THIRD LOUDSPEAKER
4 PANEL
10 SPEAKER SYSTEM
41 PERIPHERAL PORTION
42 FIRST PROJECTING PORTION
43 SECOND PROJECTING PORTION
44 OPENING
45 TRANSITION PORTION
46 THROUGH-HOLE

1. A speaker system comprising:
a first loudspeaker;
a second loudspeaker that is provided in front of the first loudspeaker and outputs a sound in a frequency range different from that of the first loudspeaker; and
a panel provided on a front surface of the second loudspeaker, wherein
the panel includes a peripheral portion provided along an outer periphery of a diaphragm of the second loudspeaker,
the panel has a diameter that is 2.5 times or less the diameter of a voice coil included in the first speaker,
a distance from a neck portion included in the first speaker to the panel is equal to an integral multiple of a wavelength or a half-wave length of a frequency band of sound output from the vicinity of the neck portion, and
in the peripheral portion, at least one through-hole penetrating the panel in a sound output direction of the first and second loudspeakers is formed at a position opposed to the neck portion along an outer peripheral direction.

2. The speaker system according to claim 1, wherein an isolation wall is provided outside the through-hole, the isolation wall extending in the sound output direction of the first and second loudspeakers and isolating a sound output from the first loudspeaker from a sound output from the second loudspeaker.

3. The speaker system according to claim 1, wherein the through-hole is formed so as to flare outward in the sound output direction of the first and second loudspeakers.

4. The speaker system according to claim 2, wherein a phase of the sound output from the first loudspeaker and a phase of the sound output from the second loudspeaker are opposite to each other.

5. The speaker system according to claim 1, wherein one end of the through-hole has the same shape as that of the other end thereof.
